(19) United States
(12) Patent Application Publication
(10) Pub. No.: US 2004/0239250 A1
(43) Pub. Date: Dec. 2, 2004

(54) Plasma display panel

(75) Inventor: Masaki Yoshinari, Yamanashi-ken (JP)

Correspondence Address: MCGINN & GIBB, PLLC, 8321 OLD COURTHOUSE ROAD, SUITE 200, VIENNA, VA, 22182-3817, US

(73) Assignee: Pioneer Corporation, Tokyo (JP)

(21) Appl. No.: 10/849,937

(22) Filed: May 21, 2004

(30) Foreign Application Priority Data
May 27, 2003 (JP) 2003-149435
May 27, 2003 (JP) 2003-149436

(51) Int. Cl. H01J 17/49

(52) U.S. Cl. 313/586; 313/582; 313/587

(57) ABSTRACT

In a plasma display panel having a front glass substrate on which row electrode pairs and column electrodes are provided, a second additional dielectric layer projects from a portion of the rear-facing face of a first additional dielectric layer opposite to a transverse wall member of the partition wall toward a back glass substrate, and extends in the row direction to provide a block between the discharge cells C adjoining to each other in the column direction on both sides of the transverse wall member. The column-electrode width of the second additional dielectric layer is smaller than that of the transverse wall member of the partition wall.

### BACKGROUND OF THE INVENTION

1. Field of the Invention

This invention relates to a panel structure for surface-discharge-type AC plasma display panels.

The present application claims priority from Japanese Applications No. 2003-149435 and No. 2003-149436, the disclosure of which is incorporated herein by reference.

2. Description of the Related Art

FIGS. 1 to 5 illustrate the panel structure of a conventional surface-discharge-type AC plasma display panel (hereinafter referred to as “PDP”). FIG. 1 is a schematic front view of the panel structure, and FIGS. 2, 3, 4 and 5 are sectional views respectively taken along the V1-V1 line, the V2-V2 line, the W1-W1 line and the W2-W2 line as shown in FIG. 1.

Referring to FIGS. 1 to 5, on the rear-facing face of a front glass substrate 1 serving as the display screen, row electrode pairs (X, Y) each extending in the row direction of the front glass substrate 1 (in the right-left direction in FIG. 1) are arranged in plurality parallel to each other.

The row electrode X is composed of a strip-shaped bus electrode Xa formed of a metal film extending in the row direction of the front glass substrate 1, and T-shaped transparent electrodes Xb each formed of a transparent conductive film made of ITO or the like. The transparent electrodes Xb are lined up along the bus electrode Xa at regular intervals and each connected to the bus electrode Xa at the proximal end (corresponding to the foot of the “T”).

Likewise, the row electrode Y is composed of a strip-shaped bus electrode Ya formed of a metal film extending in the row direction of the front glass substrate 1, and T-shaped transparent electrodes Yb each formed of a transparent conductive film made of ITO or the like. The transparent electrodes Yb are lined up along the bus electrode Ya at regular intervals and each connected to the bus electrode Ya at the proximal end (corresponding to the foot of the “T”).

The row electrodes X and Y are arranged in alternate positions in the column direction of the front glass substrate 1 (i.e. the vertical direction in FIG. 1). In each row electrode pair, the transparent electrodes Xb and Yb, which are regularly lined up along the corresponding bus electrodes Xa and Ya, extend in the direction toward their counterparts in the row electrode pair, so that the two widened-tops (corresponding to the head of the “T” shape) of the transparent electrodes Xa and Ya face each other with a discharge gap g having a required width in between.

On the rear-facing face of the front glass substrate 1, a dielectric layer 2 covers the row electrode pairs (X, Y).

Further, strip-shaped additional dielectric layers 2A are provided on the rear-facing face of the dielectric layer 2. Each of the additional dielectric layers 2A projects from the rear-facing face of the dielectric layer 2 and extends parallel to the back-to-back bus electrodes Xa, Ya of adjoining row electrode pairs (X, Y) in a position opposite the back-to-back bus electrodes Xa, Ya and the strip between the back-to-back bus electrodes Xa, Ya.

The rear-facing faces of the dielectric layer 2 and the additional dielectric layers 2A are covered with an MgO made protective layer 3.

The front glass substrate 1 is located parallel to a back glass substrate 4 with a discharge space S in between. On the front-facing face (facing toward the display screen) of the back glass substrate 4, column electrodes D are arranged at regular intervals. Each of the column electrodes D extends in the column direction in a position opposite to the paired transparent electrodes Xb and Yb of each of the row electrode pairs (X, Y).

The column electrodes D are covered with a column-electrode protective layer (dielectric layer) 5 provided on the front-facing face of the back glass substrate 4.

Then a partition wall member 6 is provided on the column-electrode protective layer 5. The partition wall member 6 is formed approximately in a grid shape having vertical walls 6A each extending in the column direction in a position between the column electrodes D regularly arranged in the row direction, and transverse walls 6B each extending in the row direction in a position opposite the additional dielectric layer 2A.

The approximate grid-shaped partition wall member 6 partitions the discharge space S into areas each facing the paired transparent electrodes Xb and Yb in each row electrode pair (X, Y) to individually form discharge cells C.

The front-facing face of the vertical wall 6A of the partition wall member 6 is out of contact with the protective layer 3 (see FIGS. 3 and 4) so as to form a clearance r therebetween. The front-facing face of the transverse wall 6B is in contact with a portion of the protective layer 3 overlying the additional dielectric layer 2A so as to block adjoining discharge cells C from each other in the column direction (see FIGS. 2 and 5).

In each discharge cell C, a phosphor layer 7 is laid on all five faces facing the discharge space, i.e. the face of the column-electrode protective layer 5 and the side faces of the vertical walls 6A and the transverse walls 6B of the partition wall member 6. The three red (R), green (G) and blue (B) colors are applied individually to the phosphor layers 7 such that the red (R), green (G) and blue (B) discharge cells C are arranged in order in the row direction.

The discharge space S is filled with a discharge gas including xenon Xe.

The PDP having the foregoing structure is described in Japanese Patent Application Laid-open No. 2000-195431.

In such a PDP, in the discharge cell C, a reset discharge and a sustaining discharge are caused between the transparent electrodes Xb and Yb of the row electrode pair (X, Y) and an addressing discharge is caused between the transparent electrode Yb of the row electrode Y and the column electrode D.

As described above, the additional dielectric layer 2A of the PDP is provided opposite to the back-to-back positioned bus electrodes Xa, Ya laid on the rear-facing face of the dielectric layer 2 and to the area between the back-to-back bus electrodes Xa and Ya. The protective layer 3 overlying this additional dielectric layer 2A is in contact with the front-facing face of the transverse wall 6B so that the adjoining discharge cells C are blocked from each other in the column direction. In this structure of the PDP, however, the area between the bus electrodes Xa, Ya of the row electrodes X, Y located on the front glass substrate 1 and the column electrodes D located on the back glass substrate 4 and intersecting with the bus electrodes Xa, Ya are packed tightly with the dielectric layers and the partition wall member. Therefore, when a potential difference is produced between the row electrode X, Y and the column electrode D (e.g. at the addressing discharge), a large interelectrode capacitance is created to generate reactive power. This causes the problem of an increase in electrical power consumption.

In another surface-discharge-type PDP which has been recently developed and has a front glass substrate on which both row electrode pairs and column electrodes are provided, because the dielectric layers individually covering the row electrode pairs and the column electrodes are laminated between the bus electrodes of the row electrodes and the back glass substrate, the interelectrode capacitance is further increased. Therefore, the problem of a further increase in electrical power consumption being effected through the occurrence of reactive power arises.

### SUMMARY OF THE INVENTION

The present invention is essentially designed to solve the problems associated with the conventional surface-discharge-type AC plasma display panel shaving a partition wall member as described hitherto.

It is, therefore, an object of the present invention to reduce power consumption by minimizing reactive power generated due to interelectrode capacitance produced in each part of a plasma display panel where dielectric layers and a partition wall member block adjoining unit light emission areas from each other.

To achieve this object, a first aspect of the present invention provides a plasma display panel comprising: a front substrate and a back substrate facing each other with a discharge space in between; a plurality of row electrode pairs each extending in a row direction and regularly arranged in a column direction to form individually display lines on a rear-facing face of the front substrate; a plurality of column electrodes provided on the rear-facing face of the front substrate, and each extending in a direction intersecting with the row electrode pairs in a position separated from the row electrode pairs by a dielectric layer provided between the row electrode pairs and the column electrodes; unit light emission areas defined in the discharge space and each located in a position facing the mutually opposite discharge portions in each row electrode pair; a partition wall provided for defining the unit light emission areas, and having at least transverse wall members extending in the row direction to provide a partition between the unit light emission areas adjoining to each other in the column direction; and additional layers each of which projects from a portion of the rear-facing face of the dielectric layer opposite the transverse wall member of the partition wall in the direction of the back substrate and extends in the row direction to provide a block between the unit light emission areas adjoining to each other in the column electrode on both sides of the transverse wall member, and has a width in the column direction (hereinafter referred to as “column-direction width”) smaller than that of the transverse wall member of the partition wall in the column direction.

With the plasma display panel according to the first aspect, because the additional layer and the transverse wall member of the partition wall provide a block between the unit light emission areas adjoining to each other in the column direction, a discharge produced in each of the unit light emission areas is prevented from spreading into another unit light emission area adjoining thereto in the column direction to develop a false discharge.

Further, the design of the column-direction width of the additional layer to be smaller than that of the transverse wall member of the partition wall successfully creates space between the transverse wall member of the partition wall and the rear-facing face of dielectric layer on which the additional layer is provided. Because of this space, there is a reduction in the interelectrode capacitances between the row electrodes, between the row electrode and the column electrode, and between the column electrodes created by the row electrodes in the row electrode pair and the column electrodes in each part of the plasma display panel where the adjoining unit light emission areas in the column direction are blocked from each other, as compared with the interelectrode capacitance in a plasma display panel using the entire column-direction width of a transverse wall member of the partition wall to block adjoining unit light emission areas from each other. As a result, the occurrence of reactive power is minimized to achieve a significant reduction in electrical power consumption.

In particular, when the plasma display panel has the row electrode pairs and the column electrodes which both are provided on the front substrate and therefore a lamination of the dielectric layers in the parts where adjoining unit light emission areas in the column direction are blocked from each other by the transverse wall member of the partition wall, the present invention offers a high degree of effectiveness in reducing the interelectrode capacitance created in the part of the plasma display panel to attain a significant reduction in electrical power consumption.

To achieve the aforementioned object, a second aspect of the present invention provides a plasma display panel comprising: a front substrate and a back substrate facing each other with a discharge space in between; a plurality of row electrode pairs each extending in a row direction and regularly arranged in a column direction to form individually display lines on a rear-facing face of the front substrate; a dielectric layer provided on the rear-facing face of the front substrate and covering the row electrode pairs; a plurality of column electrodes provided on a front-facing face of the back substrate, and each extending in a direction intersecting with the row electrode pairs; unit light emission areas defined in the discharge space and each located in a position facing mutually opposite discharge portions in each row electrode pair; a partition wall provided for defining the unit light emission areas, and having at least transverse wall members each extending in the row direction to provide a partition between the unit light emission areas adjoining to each other in the column direction; and additional layers each projecting from a portion of a rear-facing face of the dielectric layer opposite the transverse wall member of the partition wall in the direction of the back substrate and extending in the row direction to provide a block between the unit light emission areas adjoining to each other in the column electrode on both sides of the transverse wall member, and having a width in the column direction smaller than the width of the transverse wall member of the partition wall in the column direction.

With the plasma display panel according to the second aspect, because the additional layer and the transverse wall member of the partition wall provide a block between the adjoining unit light emission areas in the column direction, a discharge produced in each of the unit light emission areas is prevented from spreading into another unit light emission area adjoining thereto in the column direction to develop a false discharge.

Further, the design of the column-direction width of the additional layer to be smaller than that of the transverse wall member of the partition wall successfully creates space between the transverse wall member of the partition wall and the rear-facing face of dielectric layer on which the additional layer is provided. Because of this space, there is a reduction in the interelectrode capacitance produced by the row electrodes in the row electrode pair and the column electrodes in each part of the plasma display panel where adjoining unit light emission areas in the column direction are blocked from each other, as compared with the interelectrode capacitance in a plasma display panel using the entire column-direction width of the transverse wall members of the partition wall to block adjoining unit light emission areas from each other. As a result, the occurrence of reactive power is minimized to achieve a significant reduction in electrical power consumption.

These and other objects and features of the present invention will become more apparent from the following detailed description with reference to the accompanying drawings.

### BRIEF DESCRIPTION OF THE DRAWINGS

FIG. 1 is a schematic front view of the structure of a conventional PDP.

FIG. 2 is a sectional view taken along the V1-V1 line in FIG. 1.

FIG. 3 is a sectional view taken along the V2-V2 line in FIG. 1.

FIG. 4 is a sectional view taken along the W1-W1 line in FIG. 1.

FIG. 5 is a sectional view taken along the W2-W2 line in FIG. 1.

FIG. 6 is a schematic front view illustrating a first embodiment according to the present invention.

FIG. 7 is a sectional view taken along the V3-V3 line in FIG. 6.

FIG. 8 is a sectional view taken along the V4-V4 line in FIG. 6.

FIG. 9 is a sectional view taken along the W3-W3 line in FIG. 6.

FIG. 10 is a sectional view taken along the W4-W4 line in FIG. 6.

FIG. 11 is a schematic rear view illustrating the shape of the first additional dielectric layer and the second additional dielectric layer of a second embodiment of the present invention.

FIG. 12 is a schematic rear view illustrating the shape of the first additional dielectric layer and the second additional dielectric layer of a third embodiment of the present invention.

FIG. 13 is a schematic front view illustrating a fourth embodiment according to the present invention.

FIG. 14 is a sectional view taken along the V5-V5 line in FIG. 13.

FIG. 15 is a sectional view taken along the V6-V6 line in FIG. 13.

FIG. 16 is a sectional view taken along the W5-W5 line in FIG. 13.

FIG. 17 is a sectional view taken along the W6-W6 line in FIG. 13.

FIG. 18 is a schematic rear view illustrating the shape of the first additional dielectric layer and the second additional dielectric layer of a fifth embodiment of the present invention.

FIG. 19 is a schematic rear view illustrating the shape of the first additional dielectric layer and the second additional dielectric layer of a sixth embodiment of the present invention.

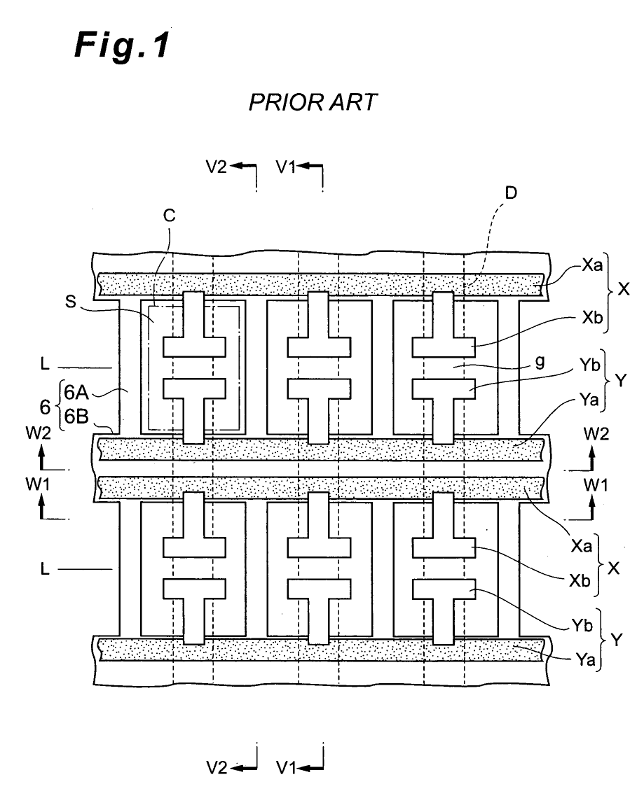

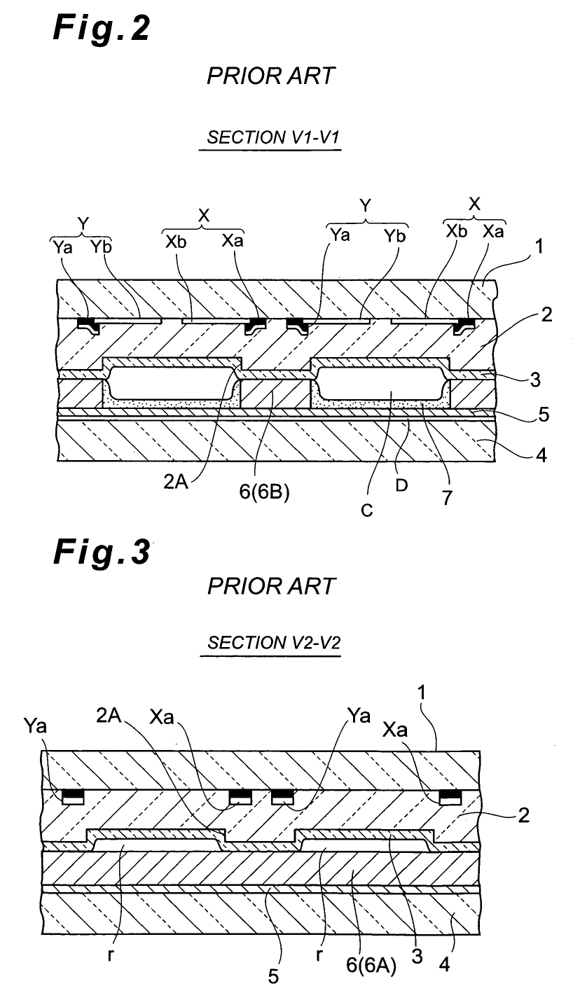

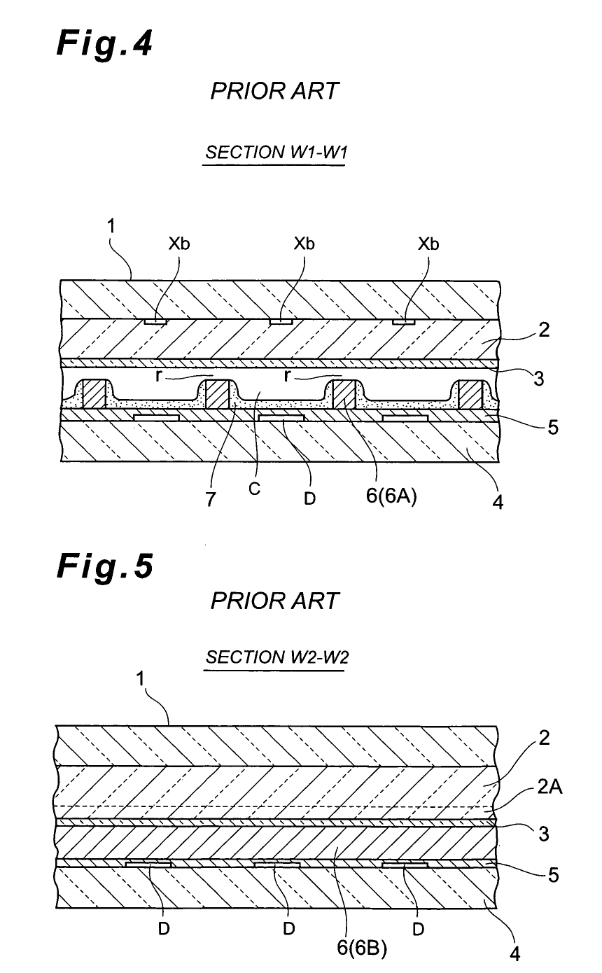

### DETAILED DESCRIPTION OF THE PREFERRED EMBODIMENTS

Preferred embodiments according to the present invention will be described below in detail with reference to the accompanying drawings.

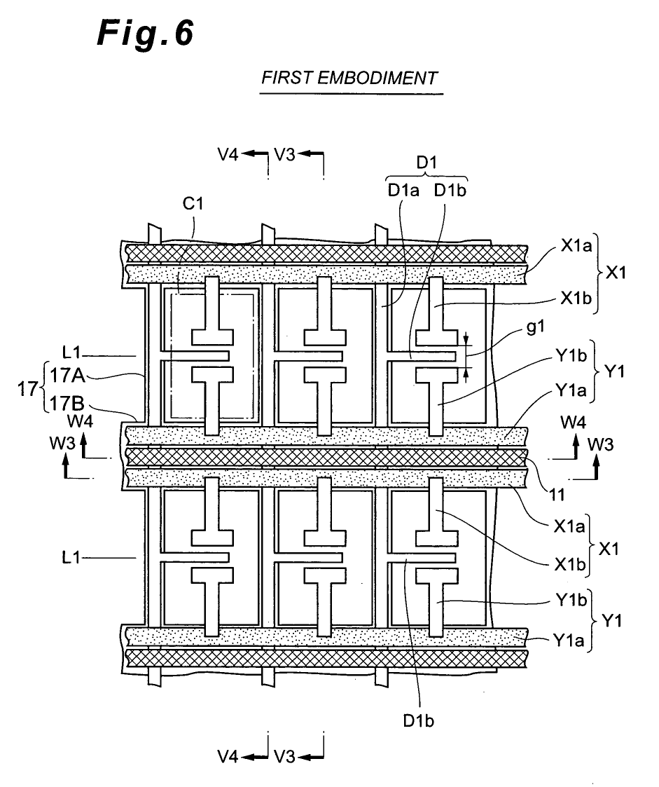

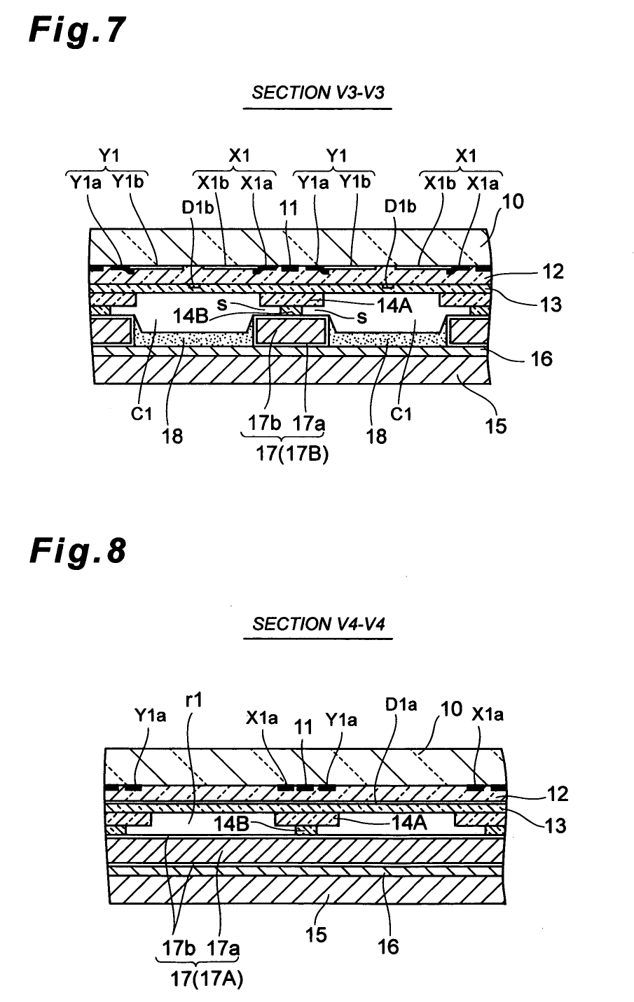

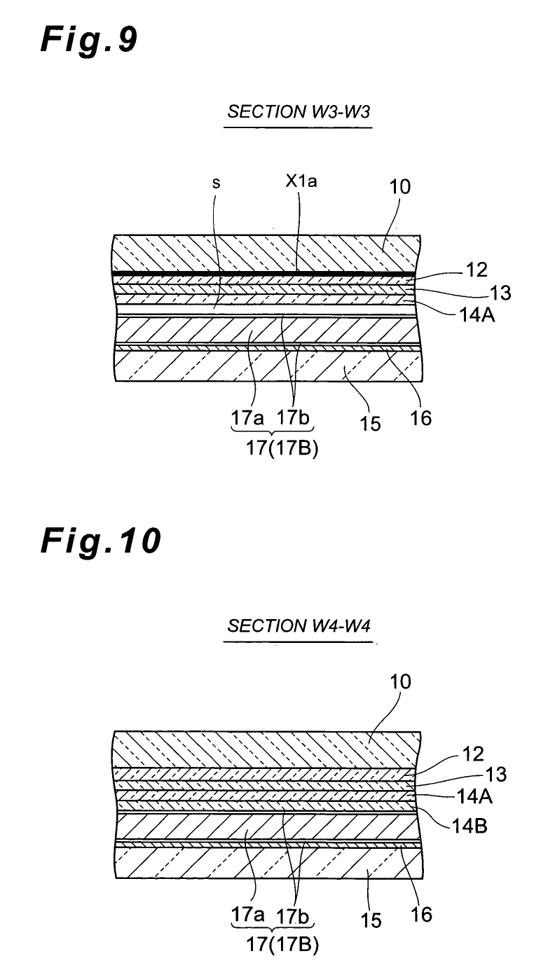

FIG. 6 to FIG. 10 illustrate a first embodiment of a plasma display panel (hereinafter referred to as “PDP”) according to the present invention: FIG. 6 is a schematic front view of a part of the PDP and FIGS. 7, 8, 9 and 10 are sectional views respectively taken along the V3-V3 line, the V4-V4 line, the W3-W3 line and the W4-W4 line as shown in FIG. 6.

The PDP illustrated in FIG. 6 to FIG. 10 has a plurality of row electrode pairs (X1, Y1) each extending in a row direction of a front glass substrate 10 (the right-left direction in FIG. 6) and arranged parallel to each other on the rear-facing face of the front glass substrate 10 serving as the display screen.

The row electrode X1 is composed of a black- or dark-colored bus electrode X1a formed of a metal film extending in the row direction of the front glass substrate 10, and T-shaped transparent electrodes X1b formed of a transparent conductive film made of ITO or the like. The transparent electrodes X1b are lined up along the bus electrode X1a at regular intervals, and connected to the bus electrode X1a at the proximal ends (corresponding to the foot of the T shape) thereof.

Likewise, the row electrode Y1 is composed of a black- or dark-colored bus electrode Y1a formed of a metal film extending in the row direction of the front glass substrate 10, and T-shaped transparent electrodes Y1b formed of a transparent conductive film made of ITO or the like. The transparent electrodes Y1b are lined up along the bus electrode Y1a at regular intervals, and connected to the bus electrode Y1a at the proximal ends (corresponding to the foot of the T shape) thereof.

The row electrodes X1 and Y1 are arranged in alternate positions in the column direction of the front glass substrate 10 (i.e. the vertical direction in FIG. 6). The transparent electrodes X1b and Y1b which are lined up along the corresponding bus electrodes X1a and Y1a in each row electrode pair at regular intervals extend in the direction of their counterpart in the row electrode pair, such that the two distal widened-ends (corresponding to the head of the T shape) of the transparent electrodes X1b and Y1b face each other with a discharge gap g1 having a required width in between.

Each of the row electrode pairs (X1, Y1) forms a display line L1 of the panel.

Black-or-dark-colored light absorption layers (light-shield layers) 11 are further provided on the rear-facing face of the front glass substrate 10. Each of the light absorption layers 11 extends in bar form in the row direction along and between the back-to-back bus electrodes X1a and Y1a of the row electrode pairs (X1, Y1) adjoining to each other in the column direction.

The row electrode pairs (X1, Y1) and the light absorption layers 11 are covered with a first dielectric layer 12 formed on the rear-facing face of the front glass substrate 10.

Column electrodes D1 each extending in the column direction are arranged in plurality at regular intervals in the row direction on the rear-facing face of the first dielectric layer 12.

Each of the column electrodes D1 is composed of a strip-shaped column-electrode body D1a and strip-shaped column-electrode discharge portions D1b. The column-electrode body D1a extends in a direction at right angles to the bus electrodes X1a, Y1a (i.e. in the column direction), and is located opposite a strip extending through mid-positions between adjacent transparent electrodes X1b and adjacent transparent electrodes Y1b which are regularly spaced along the corresponding bus electrodes X1a and Y1a of the row electrodes X1 and Y1 in the row direction. Each of the column-electrode discharge portions D1b is formed integrally with the column-electrode body D1a and extends from the long side of the column-electrode body D1a in the row direction in each display line L1 such that the leading end thereof is situated opposite the mid-position in a discharge gap g1 created between the paired transparent electrodes X1b and Y1b facing each other.

The column-electrode bodies D1a and the column-electrode discharge portions D1b of the column electrodes D1 are covered with a second dielectric layer 13 formed on the rear-facing face of the first dielectric layer 12.

First additional dielectric layers 14A project from the rear-facing face of the second dielectric layer 13 toward the rear of the PDP. Each of the additional dielectric layers 14A is formed in a strip shape extending along the back-to-back bus electrodes X1a, Y1a in the row direction in a position opposite the area in which the back-to-back bus electrodes X1a and Y1a of the adjoining row electrode pairs (X1, Y1) and the interposed light absorption layer 11 are located (i.e. a non-display zone of the panel). Each of the first additional dielectric layer 14A has approximately the same width as the column-direction width of the non-display zone.

Then, a second additional dielectric layer 14B projects from the rear-facing face of each first additional dielectric layer 14A toward the rear of the PDP, and extends in a strip shape along the light absorption layer 11 in the row direction in a position opposite the light absorption layer 11. The second additional dielectric layer 14B has approximately the same width as the distance between the back-to-back bus electrodes X1a and Y1a.

An MgO-made protective layer (not shown) is laid on the rear-facing faces of the second dielectric layer 13, the first additional dielectric layers 14A and the second additional dielectric layers 14B.

The rear-facing face of the front glass substrate 10 faces parallel to a back glass substrate 15 with a discharge space in between.

A third dielectric layer 16 is provided on the front-facing face of the back glass substrate 15 facing toward the front glass substrate 10.

On the third dielectric layer 16, a partition wall 17 formed in the following shape is provided.

The partition wall 17 is constituted by covering the surface of a metal-made base 17a with an insulation layer 17b, and is formed substantially in a grid shape constituted of strip-shaped vertical wall members 17A each extending in the column direction opposite the column-electrode body D1a provided on the front glass substrate 10, and strip-shaped transverse wall members 17B each extending in the row direction opposite the back-to-back bus electrodes X1a and Y1a of the adjoining row electrode pairs (X1, Y1) and opposite the light absorption layer 11. Each of the transverse wall members 17B has approximately the same width as the column-direction width of the area in which the back-to-back bus electrodes X1a, Y1a and the first dielectric layer 11 are located (i.e. the non-display zone).

The partition wall 17 partitions the discharge space defined between the front glass substrate 10 and the back glass substrate 15 into areas each facing the column-electrode discharge portion D1b and the paired transparent electrodes X1b and Y1b in each row electrode pair (X1, Y1), to define individual quadrangular discharge cells C1.

The front-facing face of the vertical wall member 17A of the partition wall 17 is out of contact with the protective layer covering the first additional dielectric layer 14A and the second additional dielectric layer 14B (see FIG. 8) so as to form a clearance r1. The front-facing face of the transverse wall member 17B is in contact with a portion of the protective layer overlying the second additional dielectric layer 14B to block adjoining discharge cells C1 in the column direction from each other (see FIGS. 7 and 10).

In the part forming a block between the discharge cells C1 adjoining to each other in the column direction, the column-direction width of the second additional direction layer 14B is designed to be approximately equal to the distance between the back-to-back bus electrodes X1a and Y1a, and smaller than the width of the transverse wall member 17B which is approximately the same as the column-direction width of the non-display zone of the panel (i.e. the area in which the back-to-back bus electrodes X1a, Y1a and the light absorption layer 11 are located). As a result, spaces s are created respectively along both long sides in the column direction of the second additional dielectric layer 14B between the first additional dielectric layer 14A and the front-facing face of the transverse wall member 17B.

In each discharge cell C1, a phosphor layer 18 is laid on all five faces facing the discharge cell C1, i.e. the front-facing face of the back glass substrate 15 and the side faces of the vertical wall members 17A and the transverse wall members 17B of the partition wall 17. The three primary colors, red (R), green (G) and blue (B) are applied individually to the phosphor layers 18 such that the red (R), green (G) and blue (B) discharge cells C1 are arranged in order in the row direction.

The discharge space between the front glass substrate 10 and the back glass substrate 15 is filled with a discharge gas including xenon Xe.

The aforementioned PDP generates images as follows.

First, in a simultaneous reset period, a reset discharge is produced between the row electrodes X1 and Y1 or alternatively the column-electrode discharge portion D1b of the column electrode D1 and one row electrode in the row electrode pair (X1, Y1). In an addressing period subsequent to the reset period, scan pulses are applied to the row electrodes Y1 and display data pulses indicative of the display data in the image signal are applied to the column electrodes D1, so that selectively an addressing discharge is produced between the transparent electrode Y1a of the row electrode Y1 receiving the application of the scan pulse and the column-electrode discharge portion D1b of the column electrode D1. Thereupon, wall charges are generated on the first dielectric layer 12 and the second dielectric layer 13 which face the discharge cell C1 in which the addressing discharge is produced.

Thus, light-emitting cells (the discharge cells C1 having wall charges generated on the first and second dielectric layers 12 and 13) and non-light-emitting cells (the discharge cells C1 having no wall charges generated) are distributed over the panel surface in accordance with the image to be generated.

In a sustaining emission period subsequent to the addressing period, discharge-sustaining pulses are applied to the row electrodes X1 and Y1. Thereupon, in each light-emitting cell having wall charges generated on the first and second dielectric layers 12 and 13, a sustain discharge is produced between the transparent electrodes X1b and Y1b of the row electrodes X1 and Y1 facing each other with the discharge gap g1 in between.

As a result of the sustain discharge, vacuum ultraviolet light radiates from the xenon included in the discharge gas filling the discharge space. The vacuum ultraviolet light excites each of the phosphor layers 18 of the red (R), green (G) and blue (B) colors to allow the phosphor layers 18 to emit visible light for the generation of the image to be matrix-displayed.

With this structure of the PDP, a discharge generated in one discharge cell C1 is prevented from spreading into another discharge cell C1 adjacent thereto in the column direction to develop a false discharge. This is because the protective layer covering the second additional dielectric layer 14B is in contact with the transverse wall member 17B of the partition wall 17 to block the adjoining discharge cells C1 from each other in the column direction.

Further, the PDP has the spaces s provided respectively along both long sides of the second additional dielectric layer 14B between the transverse wall member 17B and the first additional dielectric layer 14A in the part forming a block between the adjoining discharge cells C1 in the column direction. The space s is filled with the discharge gas, so that the relative dielectric constant in this area is close to one.

In consequence, as compared with the PDP of the conventional structure, a reduced interelectrode capacitance is produced between the bus electrodes X1a, Y1a of the row electrodes X1, Y1 and the back glass substrate 15. The reactive power is thereby minimized, resulting in a significant reduction in electrical power consumption.

As in the foregoing PDP, in particular, in a PDP in which both the row electrode pairs (X1, Y1) and the column electrodes D1 are provided on the front glass substrate 10 and therefore the first dielectric layer 12 and the second dielectric layer 13 are laminated in the part of the PDP where the transverse wall member 17B blocks the adjoining discharge cells C1 from each other in the column direction, the effect of reducing the interelectrode capacitances between the bus electrodes X1a and Y1a, between the bus electrode X1a/Y1a and the column electrode D1a, and between the column-electrode main bodies D1a produced in the above part is enhanced to achieve a significant reduction in electrical power consumption.

Further, when the base of the partition wall 17 is formed as a metal base, the PDP of the conventional structure has a large interelectrode capacitance created in each part thereof where the adjoining discharge cells in the column direction are blocked from each other by the metal-made transverse wall member. In this case, as in the PDP described in the first embodiment, by providing discharge-gas-filled spaces s along both long sides of the second additional dielectric layer 14B between the first additional dielectric layer 14A and the transverse wall member 17B, it becomes possible to dramatically reduce the amount of the increase in interelectrode capacitance caused by the use of a metal-made partition wall as the partition wall 17, resulting in an effective reduction in electrical power consumption because of the reduced reactive power.

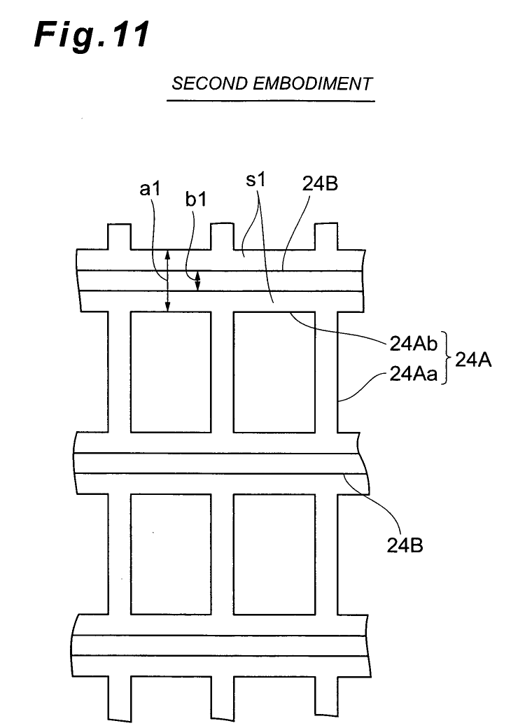

FIG. 11 is a rear view of the shapes of a first additional dielectric layer and a second additional dielectric layer in a second embodiment of a PDP according to the present invention, when viewed from the rear-facing face of the front glass substrate.

In FIG. 11, the first additional dielectric layer 24A is formed approximately in the same grid shape as the approximate grid shape of a partition wall (not shown, see the partition wall 17 in the first embodiment) by being constituted of vertical strips 24Aa each extending in the column direction and transverse strips 24Ab each extending in the row direction.

Each of the second additional dielectric layers 24B is laid on and extends along a central portion of the rear-facing face of the transverse strip 24Ab of the first additional dielectric layer 24A, and extends in the row direction parallel to the transverse strip 24Ab. The second additional dielectric layer 24B has a column-direction width b1 smaller than the column-direction width al of the transverse strip 24Ab of the first additional dielectric layer 24A.

As in the case of the first embodiment, the second additional dielectric layer 24B is in contact with the transverse wall member of the partition wall to block the adjoining discharge cells from each other in the column direction. Then, spaces s1 are respectively created along both long sides of the second additional dielectric layer 24B between the transverse strip 24Ab of the first additional dielectric layer 24A and the transverse wall member of the partition wall, so that the interelectrode capacity created in the space is reduced.

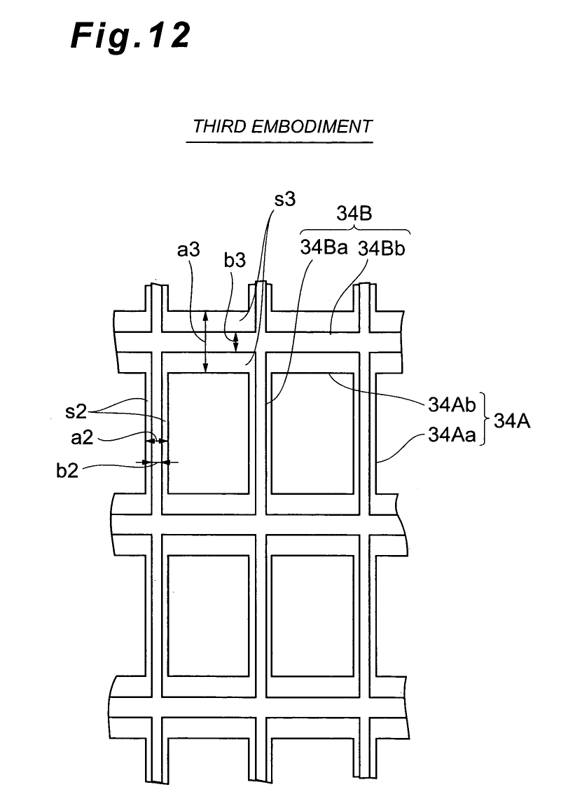

FIG. 12 is a rear view of the shapes of a first additional dielectric layer and a second additional dielectric layer in a third embodiment of a PDP according to the present invention, when viewed from the rear-facing face of the front glass substrate.

In FIG. 12, the first additional dielectric layer 34A is formed approximately in the same grid shape as the approximate grid shape of a partition wall (not shown, see the partition wall 17 in the first embodiment) by being constituted of vertical strips 34Aa each extending in the column direction and transverse strips 34Ab each extending in the row direction.

The second additional dielectric layer 34B formed on the rear-facing face. of the first additional dielectric layer 34A is also formed approximately in the grid shape by being constituted of vertical wall portions 34Ba and transverse wall portions 34Ab. Each of the vertical wall portions 34Ba extends along a central portion of the vertical strip 34Aa of the first additional dielectric layer 34A in the column direction, and has a width b2 in the row direction (hereinafter referred to as “row-direction width”) smaller than the row-direction width a2 of the vertical strip 34Aa of the first additional dielectric layer 34A. Each of the transverse wall portions 34Bb extends along a central portion of the transverse strip 34Ab of the first additional dielectric layer 34A in the row direction, and has a column-direction width b3 smaller than the column-direction width a3 of the transverse strip 34Ab of the first additional dielectric layer 34A.

The vertical wall portion 34Ba of the approximate grid-shaped second additional dielectric layer 34B is in contact with the vertical wall member of the partition wall to block the adjoining discharge cells from each other in the row direction. Further, as in the case of the first embodiment, the transverse wall portion 34Bb is in contact with the transverse wall member of the partition wall to block the adjoining discharge cells from each other in the column direction.

Then, spaces s2 are respectively created along both long sides of the vertical wall portion 34Ba of the second additional dielectric layer 34B between the vertical strip 34Aa of the first additional dielectric layer 34A and the vertical wall member of the partition wall, and thus the interelectrode capacity created between the back glass substrate and a column-electrode body which is formed on the front glass substrate and opposite the vertical wall member of the partition wall (see the column-electrode body D1a in the first embodiment) is reduced. Further, spaces s3 are respectively created along both long sides of the transverse wall portion 34Bb of the second additional dielectric layer 34B between the transverse strip 34Ab of the first additional dielectric layer 34A and the vertical wall member of the partition wall, and thus the interelectrode capacity created between the back glass substrate and a bus electrode of the row electrode formed on the front glass substrate is reduced.

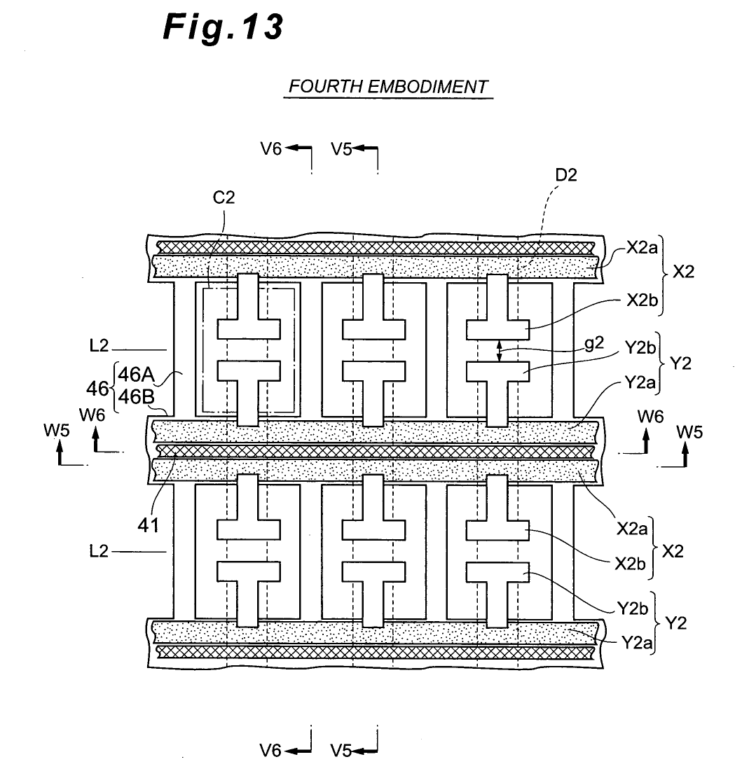

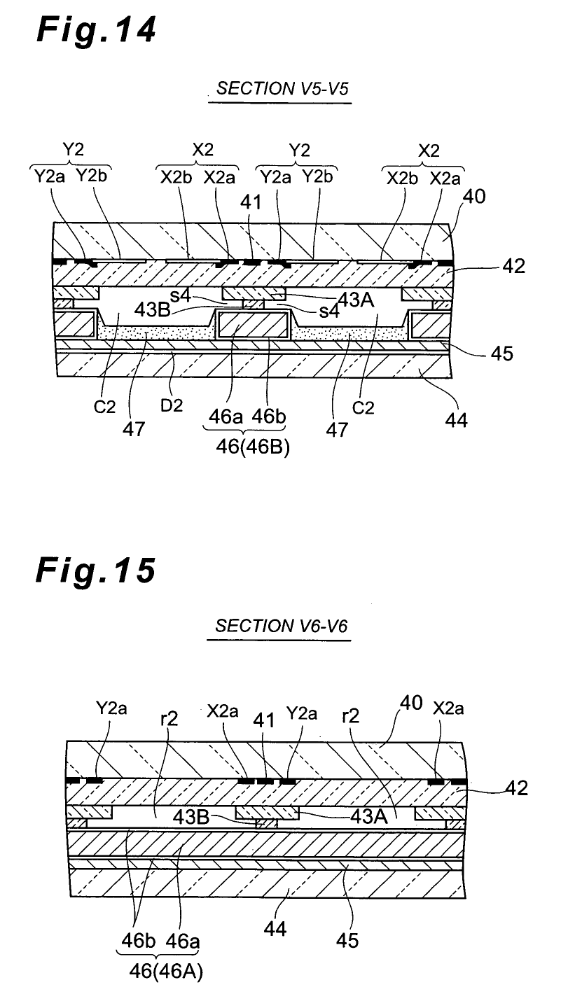

FIG. 13 to FIG. 17 illustrate a fourth embodiment of a plasma display panel (hereinafter referred to as “PDP”) according to the present invention: FIG. 13 is a schematic front view of a part of the PDP and FIGS. 14, 15, 16 and 17 are sectional views respectively taken along the V5-V5 line, the V6-V6 line, the W5-W5 line and the W6-W6 line as shown in FIG. 13.

In FIG. 13 to FIG. 17, a plurality of row electrode pairs (X2, Y2) each extending in a row direction of a front glass substrate 40 (the right-left direction in FIG. 13) are arranged parallel to each other on the rear-facing face of the front glass substrate 40 serving as the display screen.

The row electrode X2 is composed of a black- or dark-colored bus electrode X2a formed of a metal film extending in the row direction of the front glass substrate 40, and T-shaped transparent electrodes X2b formed of a transparent conductive film made of ITO or the like. The transparent electrodes X2b are lined up along the bus electrode X2a at regular intervals, and connected to the bus electrode X2a at the proximal ends (corresponding to the foot of the T shape) thereof.

Likewise, the row electrode Y2 is composed of a black- or dark-colored bus electrode Y2a formed of a metal film extending in the row direction of the front glass substrate 40, and T-shaped transparent electrodes Y2b formed of a transparent conductive film made of ITO or the like. The transparent electrodes Y2b are lined up along the bus electrode Y2a at regular intervals, and connected to the bus electrode Y2a at the proximal ends (corresponding to the foot of the T shape) thereof.

The row electrodes X2 and Y2 are arranged in alternate positions in the column direction of the front glass substrate 40 (i.e. the vertical direction in FIG. 13). The transparent electrodes X2b and Y2b which are lined up along the corresponding bus electrodes X2a and Y2a in each row electrode pair at regular intervals extend in the direction of their counterpart in the row electrode pair, such that the two distal widened-ends (corresponding to the head of the T shape) of the transparent electrodes X2b and Y2b face each other with a discharge gap g2 having a required width in between.

Each of the row electrode pairs (X2, Y2) forms a display line L2 of the panel.

Black- or dark-colored light absorption layers (light-shield layers) 41 are further provided on the rear-facing face of the front glass substrate 40. Each of the light absorption layers 41 extends in bar form in the row direction along and between the back-to-back bus electrodes X2a and Y2a of the row electrode pairs (X2, Y2) adjoining to each other in the column direction.

The row electrode pairs (X2, Y2) and the light absorption layers 41 are covered with a dielectric layer 42 formed on the rear-facing face of the front glass substrate 40.

First additional dielectric layers 43A project from the rear-facing face of the dielectric layer 42 toward the rear of the PDP. Each of the first additional dielectric layers 43A is formed in a strip shape extending along the back-to-back bus electrodes X2a, Y2a in the row direction in a position opposite the area in which the back-to-back bus electrodes X2a and Y2a of the adjoining row electrode pairs (X2, Y2) and the interposed light absorption layer 41 are located (i.e. a non-display zone). Each of the first additional dielectric layer 43A has approximately the same width as the column-direction width of the non-display zone.

A second additional dielectric layer 43B projects from the rear-facing face of each first additional dielectric layer 43A toward the rear of the PDP, and extends in a strip shape along the light absorption layer 41 in the row direction in a position opposite the light absorption layer 41. The second additional dielectric layer 43B has approximately the same width as the distance between the back-to-back bus electrodes X2a and Y2a.

An MgO-made protective layer (not shown) is laid on the rear-facing faces of the dielectric layer 42, the first additional dielectric layers 43A and the second additional dielectric layers 43B.

The front glass substrate 40 is disposed parallel to a back glass substrate 44 with a discharge space in between.

On the front-facing face of the back glass substrate 44 facing toward the front glass substrate 40, column electrodes D2 are arranged at regular intervals in the row direction and each extend in the column direction through positions each opposite to the paired transparent electrodes X2b and Y2b in each row electrode pair (X2, Y2).

The column electrodes D2 are covered with a column-electrode protective layer 45 formed on the front-facing face of the back glass substrate 44.

On the column-electrode protective layer 45, a partition wall 46 formed in the following shape is provided.

The partition wall 46 is constituted by covering the surface of a metal-made base 46a with an insulation layer 46b, and is formed substantially in a grid shape constituted of strip-shaped vertical wall members 46A each extending in the column direction and strip-shaped transverse wall members 46B each extending in the row direction. Each of the vertical wall members 46A is located opposite a strip extending through mid-positions between adjacent transparent electrodes X2b and adjacent transparent electrodes Y2b which are regularly spaced along the corresponding bus electrodes X2a and Y2a of the row electrodes X2 and Y2 in the row direction. Each of the transverse wall members 46B is located opposite the non-display zone in which the back-to-back bus electrodes X2a and Y2a of the adjoining row electrode pairs (X2, Y2) and the light absorption layer 41 are located. Each of the transverse wall members 46B has approximately the same width as the column-direction width of the non-display zone.

The partition wall 46 partitions the discharge space defined between the front glass substrate 40 and the back glass substrate 44 into areas each facing the paired transparent electrodes X2b and Y2b in each row electrode pair (X2, Y2) to define individual quadrangular discharge cells C2.

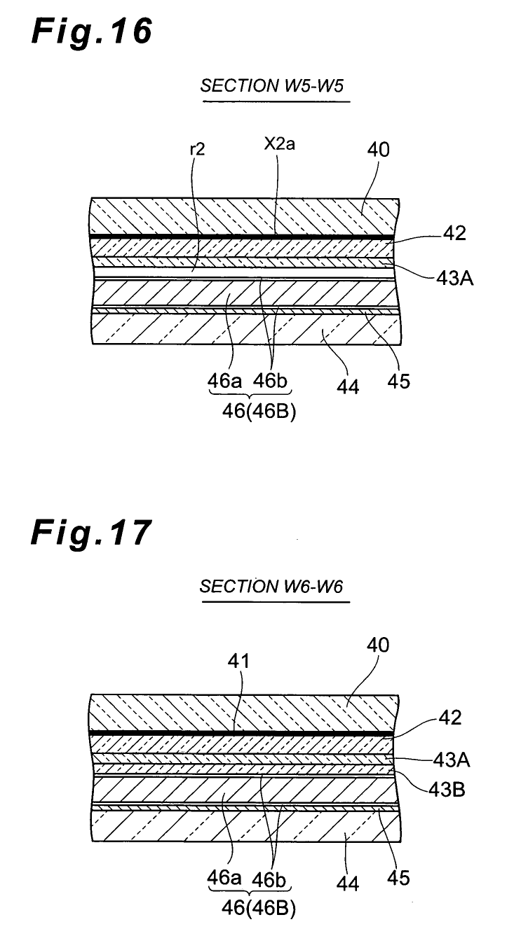

The front-facing face of the vertical wall member 46A of the partition wall 46 is out of contact with the protective layer covering the first additional dielectric layer 46A and the second additional dielectric layer 46B (see FIGS. 15 and 16) so as to form a clearance r2. The front-facing face of the transverse wall member 46B is in contact with a portion of the protective layer overlying the second additional dielectric layer 43B to block adjoining discharge cells C2 in the column direction from each other (see FIGS. 14 and 17).

In the part forming a block between the discharge cells C2 adjoining to each other in the column direction, the column-direction width of the second additional direction layer 43B is designed to be approximately equal to the distance between the back-to-back bus electrodes X2a and Y2a, and smaller than the width of the transverse wall member 46B which is approximately the same as the column-direction width of the non-display zone of the panel (i.e. the area in which the back-to-back bus electrodes X2a, Y2a and the light absorption layer 41 are located). As a result, spaces s4 are created respectively along both long sides in the column direction of the second additional dielectric layer 43B between the first additional dielectric layer 43A and the front-facing face of the transverse wall member 46B.

In each discharge cell C2, a phosphor layer 47 is laid on all five faces facing the discharge cell C2, i.e. the face of the column-electrode protective layer 45 and the side faces of the vertical wall members 46A and the transverse wall members 46B of the partition wall 46. The three primary colors, red (R), green (G) and blue (B) are applied individually to the phosphor layers 47 such that the red (R), green (G) and blue (B) discharge cells C2 are arranged in order in the row direction.

The discharge space between the front glass substrate 40 and the back glass substrate 44 is filled with a discharge gas including xenon Xe.

The aforementioned PDP generates images as follows.

First, in a simultaneous reset period, a reset discharge is produced between the row electrodes X2 and Y2 or alternatively the column electrode D2 and one row electrode in the row electrode pair (X2, Y2). In an addressing period subsequent to the reset period, scan pulses are applied to the row electrodes Y2 and display data pulses indicative of the display data in the image signal are applied to the column electrodes D2, so that selectively an addressing discharge is produced between the column electrode D2 and the transparent electrode Y2a of the row electrode Y2 receiving the application of the scan pulse. Thereupon, wall charges are generated on the dielectric layer 42 facing the discharge cell C2 in which the addressing discharge is produced.

Thus, light-emitting cells (the discharge cells C2 having wall charges generated on the dielectric layer 42) and non-light-emitting cells (the discharge cells C2 having no wall charges generated on the dielectric layer 42) are distributed over the panel surface in accordance with the image to be generated.

In a sustaining emission period subsequent to the addressing period, discharge-sustaining pulses are applied alternately to the row electrodes X2 and Y2. Thereupon, in each light-emitting cell having wall charges generated on the dielectric layers 42, a sustain discharge is produced between the transparent electrodes X2b and Y2b of the row electrodes X2 and Y2 facing each other with the discharge gap g2 in between.

As a result of the sustain discharge, vacuum ultraviolet light radiates from the xenon included in the discharge gas filling the discharge space. The vacuum ultraviolet light excites each of the phosphor layers 47 of the red (R), green (G) and blue (B) colors to allow the phosphor layers 47 to emit visible light for the generation of the image to be displayed in matrix form.

With this structure of the PDP, a discharge generated in one discharge cell C2 is prevented from spreading into another discharge cell C2 adjacent thereto in the column direction to develop a false discharge. This is because the protective layer covering the second additional dielectric layer 43B is in contact with the transverse wall member 46B of the partition wall 46 to block the adjoining discharge cells C2 from each other in the column direction.

Further, the PDP has the spaces s4 provided respectively along both long sides of the second additional dielectric layer 43B between the transverse wall member 46B and the first additional dielectric layer 43A in the part forming a block between the adjoining discharge cells C2 in the column direction. The space s4 is filled with the discharge gas, so that the relative dielectric constant in this area is close to one.

For this reason, for example, when a potential difference is produced between one row electrode (the row electrode Y2 in this case) in the row electrode pair (X2, Y2) and the column electrode D2 for a reset discharge or addressing discharge, as compared with the PDP of the conventional structure, a reduced interelectrode capacitance is produced between the bus electrode X2a and the column electrode D2. The reactive power is thereby minimized, resulting in a significant reduction in electrical power consumption.

In particular, when the base 46a of the partition wall 46 is made of metal, the PDP of the conventional structure has a large interelectrode capacitance created in each part where the adjoining discharge cells in the column direction are blocked from each other by the metal-made transverse wall member. In this case, as in the PDP described in the fourth embodiment, by providing discharge-gas-filled spaces s4 along both long sides of the second additional dielectric layer 43B between the first additional dielectric layer 43A and the transverse wall member 46B, it becomes possible to dramatically reduce the amount of the increase in interelectrode capacitance caused by the use of a metal-made partition wall as the partition wall 46, resulting in an effective reduction in electrical power consumption because of the reduced reactive power.

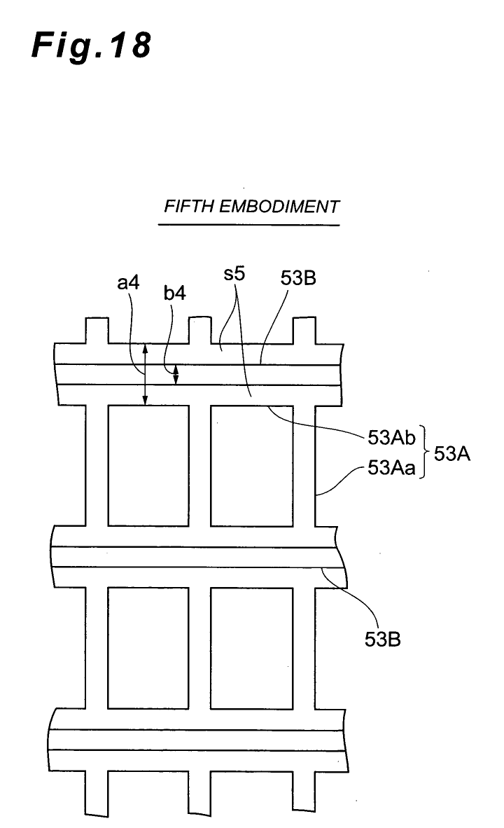

FIG. 18 is a rear view of the shapes of a first additional dielectric layer and a second additional dielectric layer in a fifth embodiment of a PDP according to the present invention, when viewed from the rear-facing face of the front glass substrate.

In FIG. 18, the first additional dielectric layer 53A is formed approximately in the same grid shape as the approximate grid shape of a partition wall (not shown, see the partition wall 46 in the fourth embodiment) by being constituted of vertical strips 53Aa each extending in the column direction and transverse strips 53Ab each extending in the row direction.

Each of the second additional dielectric layers 53B laid on the first additional dielectric layer 53A extends along a central portion of the rear-facing face of the transverse strip 53Ab of the first additional dielectric layer 53A in the row direction parallel to the transverse strip 53Ab. The second additional dielectric layer 53B has a column-direction width b4 smaller than the column-direction width a4 of the transverse strip 53Ab of the first additional dielectric layer 53A.

As in the case of the first embodiment, the second additional dielectric layer 53B is in contact with the transverse wall member of the partition wall to block the adjoining discharge cells from each other in the column direction. Then, spaces s5 are respectively created along both long sides of the second additional dielectric layer 53B between the transverse strip 53Ab of the first additional dielectric layer 53A and the transverse wall member of the partition wall, so that the interelectrode capacity created in the space is reduced.

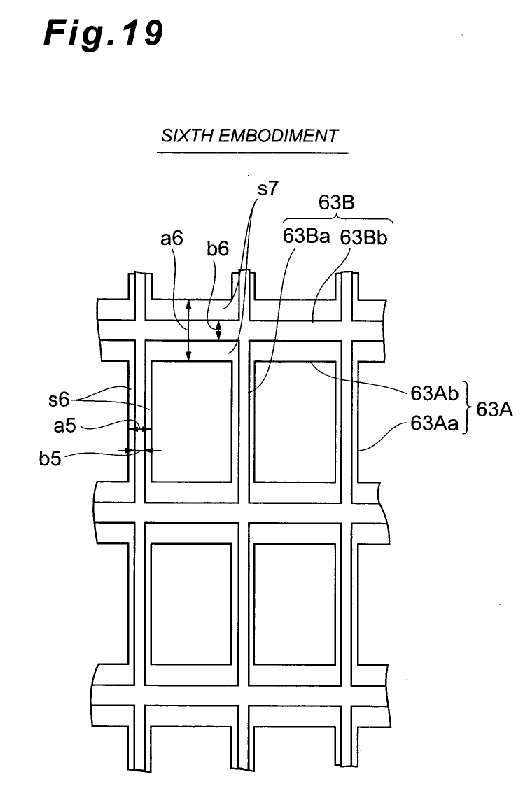

FIG. 19 is a rear view of the shapes of a first additional dielectric layer and a second additional dielectric layer in a sixth embodiment of a PDP according to the present invention, when viewed from the rear-facing face of the front glass substrate.

In FIG. 19, the first additional dielectric layer 63A is formed approximately in the same grid shape as the approximate grid shape of a partition wall (not shown, see the partition wall 46 in the fourth embodiment) by being constituted of vertical strips 63Aa each extending in the column direction and transverse strips 63Ab each extending in the row direction.

The second additional dielectric layer 63B laid on the rear-facing face of the first additional dielectric layer 63A is also formed approximately in the grid shape by being constituted of vertical wall portions 63Ba and transverse wall portions 63Bb. Each of the vertical wall portions 63Ba extends along a central portion of the vertical strip 63Aa of the first additional dielectric layer 63A in the column direction, and has a row-direction width b5 smaller than the row-direction width a5 of the vertical strip 63Aa of the first additional dielectric layer 63A. Each of the transverse wall portions 63Bb extends along a central portion of the transverse strip 63Ab of the first additional dielectric layer 63A in the row direction, and has a column-direction width b6 smaller than the column-direction width a6 of the transverse strip 63Ab of the first additional dielectric layer 63A.

The vertical wall portion 63Ba of the approximate grid-shaped second additional dielectric layer 63B is in contact with the vertical wall member of the partition wall to block the adjoining discharge cells from each other in the row direction. Further, as in the case of the fourth embodiment, the transverse wall portion 63Bb is in contact with the transverse wall member of the partition wall to block the adjoining discharge cells from each other in the column direction.

Then, spaces s6 are respectively created along both long sides of the vertical wall portion 63Ba of the second additional dielectric layer 63B between the vertical strip 63Aa of the first additional dielectric layer 63A and the vertical wall member of the partition wall. Further, spaces s7 are respectively created along both long sides of the transverse wall portion 63Bb of the second additional dielectric layer 63B between the transverse strip 63Ab of the first additional dielectric layer 63A and the vertical wall member of the partition wall, and thus the interelectrode capacity created between the row electrode and the column electrode is reduced.

The terms and description used herein are set forth by way of illustration only and are not meant as limitations. Those skilled in the art will recognize that numerous variations are possible within the spirit and scope of the invention as defined in the following claims.

What is claimed is:

1. A plasma display panel comprising:
a front substrate and a back substrate facing each other with a discharge space in between;
a plurality of row electrode pairs each extending in a row direction and regularly arranged in a column direction to form individually display lines on a rear-facing face of the front substrate;
a plurality of column electrodes provided on the rear-facing face of the front substrate, and each extending in a direction intersecting with the row electrode pairs in a position separated from the row electrode pairs by a dielectric layer provided between the row electrode pairs and the column electrodes;
unit light emission areas defined in the discharge space and each located in a position facing mutually opposite discharge portions in each row electrode pair;
a partition wall provided for defining the unit light emission areas, and having at least transverse wall members each extending in the row direction to provide a partition between the unit light emission areas adjoining to each other in the column direction; and
additional layers each projecting from a portion of a rear-facing face of the dielectric layer opposite the transverse wall member of the partition wall in the direction of the back substrate and extending in the row direction to provide a block between the unit light emission areas adjoining to each other in the column electrode on both sides of the transverse wall member, and having a width in the column direction smaller than the width of the transverse wall member of the partition wall in the column direction.

2. A plasma display panel according to claim 1, wherein the partition wall has vertical wall members each extending in the column direction to provide a partition between the unit light emission areas adjoining to each other in the row direction.

3. A plasma display panel according to claim 2, further comprising another additional layers each projecting from a portion of the rear-facing face of the dielectric layer opposite the vertical wall member of the partition wall toward the back substrate and extending in the column direction to provide a block between the unit light emission areas adjoining to each other in the row electrode on both sides of the vertical wall.

4. A plasma display panel according to claim 3, wherein the additional layer opposite to the vertical wall member of the partition wall has a width in the row direction smaller than the width of the vertical wall member of the partition wall in the row direction.

5. A plasma display panel according to claim 1, wherein the partition wall is constituted by covering the entire surface of a metal-made base with an insulation layer.

6. A plasma display panel according to claim 1,
wherein each of the row electrodes constituting the row electrode pair has a row electrode body extending in the row direction, and the discharge portions each extending from the row electrode body toward the other row electrode of the row electrodes paired with each other in each unit light-emission area to face each other with a discharge gap; and
wherein the additional layer facing the transverse wall member of the partition wall is located opposite an area between the back-to-back positioned row electrode bodies of the row electrode pairs adjoining to each other in the column direction.

7. A plasma display panel according to claim 6, further comprising an additional dielectric layer provided on a portion of the rear-facing face of the dielectric layer opposite the back-to-back positioned row electrode bodies of the row electrode pairs adjoining to each other in the column direction and the area between the back-to-back positioned row electrode bodies, and projecting from the portion of the dielectric layer toward the back substrate,
wherein the additional layer is provided on a rear-facing face of the additional dielectric layer.

8. A plasma display panel comprising:
a front substrate and a back substrate facing each other with a discharge space in between;
a plurality of row electrode pairs each extending in a row direction and regularly arranged in a column direction to form individually display lines on a rear-facing face of the front substrate;
a dielectric layer provided on the rear-facing face of the front substrate and covering the row electrode pairs;
a plurality of column electrodes provided on a front-facing face of the back substrate, and each extending in a direction intersecting with the row electrode pairs;
unit light emission areas defined in the discharge space and each located in a position facing mutually opposite discharge portions in each row electrode pair;
a partition wall provided for defining the unit light emission areas, and having at least transverse wall members each extending in the row direction to provide a partition between the unit light emission areas adjoining to each other in the column direction; and
additional layers each projecting from a portion of a rear-facing face of the dielectric layer opposite the transverse wall member of the partition wall in the direction of the back substrate and extending in the row direction to provide a block between the unit light emission areas adjoining to each other in the column electrode on both sides of the transverse wall member, and having a width in the column direction smaller than the width of the transverse wall member of the partition wall in the column direction.

9. A plasma display panel according to claim 8, wherein the partition wall has vertical wall members each extending in the column direction to provide a partition between the unit light emission areas adjoining to each other in the row direction.

10. A plasma display panel according to claim 9, further comprising another additional layers each projecting from a portion of the rear-facing face of the dielectric layer opposite the vertical wall member of the partition wall toward the back substrate and extending in the column direction to provide a block between the unit light emission areas adjoining to each other in the row electrode on both sides of the vertical wall.

11. A plasma display panel according to claim 10, wherein the additional layer opposite to the vertical wall member of the partition wall has a width in the row direction smaller than the width of the vertical wall member of the partition wall in the row direction.

12. A plasma display panel according to claim 8, wherein the partition wall is constituted by covering the entire surface of a metal-made base with an insulation layer.

13. A plasma display panel according to claim 8,
wherein each of the row electrodes constituting the row electrode pair has a row electrode body extending in the row direction, and the discharge portions each extending from the row electrode body toward the other row electrode of the row electrodes paired with each other in each unit light-emission area to face each other with a discharge gap; and
wherein the additional layer facing the transverse wall member of the partition wall is located opposite an area between the back-to-back positioned row electrode bodies of the row electrode pairs adjoining to each other in the column direction.

14. A plasma display panel according to claim 13, further comprising an additional dielectric layer provided on a portion of the rear-facing face of the dielectric layer opposite the back-to-back positioned row electrode bodies of the row electrode pairs adjoining to each other in the column direction and the area between the back-to-back positioned row electrode bodies, and projecting from the portion of the dielectric layer toward the back substrate,
wherein the additional layer is provided on a rear-facing face of the additional dielectric layer.
